(19) United States
(12) Patent Application Publication
(10) Pub. No.: US 2026/0004472 A1
(43) Pub. Date: Jan. 1, 2026

(54) INFORMATION PROCESSING METHOD AND APPARATUS, DEVICE, AND MEDIUM

(71) Applicant: Beijing Zitiao Network Technology Co., Ltd., Beijing (CN)

(72) Inventors: Cheng CHEN, Beijing (CN); Xiang TIAN, Beijing (CN); Chaoying CAI, Beijing (CN); Weichen WANG, Beijing (CN); Qian MENG, Beijing (CN)

(21) Appl. No.: 19/253,587

(22) Filed: Jun. 27, 2025

(30) Foreign Application Priority Data
Jun. 27, 2024 (CN) 202410851500.X

(51) Int. Cl. G06T 11/00; G06F 3/0482; G06F 3/04845; G06F 3/04847

(52) U.S. Cl. CPC G06T 11/00; G06F 3/0482; G06F 3/04845; G06F 3/04847

(57) ABSTRACT

Embodiments of the present disclosure relate to an information processing method and apparatus, a device, and a medium. The method includes: displaying a first interface, where the first interface presents a task creation control; displaying a second interface in response to the task creation control being triggered, where the second interface displays a task name setting control and a parameter setting control; obtaining, by the task name setting control, a name of a target task to be performed, and obtaining, by the parameter setting control, a target parameter corresponding to the target task, where there is at least one category of target parameters, and each category of the target parameters corresponds to at least one parameter value; and providing the target parameter to a target generation model causing the target generation model generates a target image corresponding to the target task based on the target parameter.

### CROSS-REFERENCE TO RELATED APPLICATION(S)

This application claims priority to Chinese Application No. 202410851500.X filed in Jun. 27, 2024, the disclosure of which is incorporated herein by reference in its entirety.

### FIELD

The present disclosure relates to the field of information processing technologies, and in particular, to an information processing method and apparatus, a device, and a medium.

### BACKGROUND

With the development of artificial intelligence, in many scenarios, neural networks such as generation models are needed to generate images. Especially, in certain scenarios such as a material production scenario or an effect comparison scenario, there is a high requirement on the number of images generated and a strong demand for batch generation of images.

### SUMMARY

In order to solve the above technical problem or at least partially solve the above technical problem, the present disclosure provides an information processing method and apparatus, a device, and a medium.

An embodiment of the present disclosure provides an information processing method. The method includes: displaying a first interface, where the first interface presents a task creation control; displaying a second interface in response to the task creation control being triggered, where the second interface displays a task name setting control and a parameter setting control; obtaining, by the task name setting control, a name of a target task to be performed, and obtaining, by the parameter setting control, a target parameter corresponding to the target task, where there is at least one category of target parameters, and each category of the target parameters corresponds to at least one parameter value; and providing the target parameter to a target generation model causing the target generation model to generate a target image corresponding to the target task based on the target parameter, where a number of target images is determined based on a number of parameter values corresponding to each category of target parameters.

Optionally, the parameter setting control includes a parameter addition sub-control, a parameter category setting sub-control, a parameter type selection sub-control, and a parameter information setting sub-control; and the obtaining, by the parameter setting control, a target parameter corresponding to the target task includes: displaying, in response to the parameter addition sub-control being triggered, a parameter category setting sub-control, a parameter type selection sub-control, and a parameter information setting sub-control that correspond to a parameter to be added; determining, by the parameter category setting sub-control, a parameter category name corresponding to the parameter to be added, and determining, by the parameter type selection sub-control, a parameter type corresponding to the parameter to be added, where the parameter category name is a custom name, and the parameter type includes a single-parameter type or a combined parameter type; and displaying, based on the parameter type corresponding to the parameter to be added, the parameter information setting sub-control corresponding to the parameter to be added, obtaining, by the parameter information setting sub-control corresponding to the parameter to be added, parameter information of the parameter to be added, and determining the target parameter corresponding to the target task based on the parameter information of the parameter to be added.

Optionally, the displaying, based on the parameter type corresponding to the parameter to be added, the parameter information setting sub-control corresponding to the parameter to be added includes: displaying a first parameter information setting sub-control for setting an independent parameter item when the parameter type corresponding to the parameter to be added is the single-parameter type; or displaying a second parameter information setting sub-control for setting at least two parameter items with a correspondence when the parameter type corresponding to the parameter to be added is the combined parameter type.

Optionally, the parameter information setting sub-control includes a parameter item setting sub-control and a parameter value setting sub-control; and the obtaining, by the parameter information setting sub-control corresponding to the parameter to be added, parameter information of the parameter to be added includes: displaying a parameter item list by the parameter item setting sub-control, and obtaining, based on a selection operation for the parameter item list, a parameter item of the parameter to be added, where parameter items in the parameter item list are read from an execution tool of the target task, and each category of parameters to be added corresponds to at least one parameter item; and obtaining, by the parameter value setting sub-control, at least one parameter value corresponding to the parameter item of the parameter to be added.

Optionally, the method further includes: displaying, on a third interface, a target parameter list and a predicted number of images generated, where the target parameter list is used to present parameter information of the target parameter and a modify control corresponding to the target parameter, the predicted number of images generated is a predicted number of target images that are obtained by performing the target task based on the target parameter, and the predicted number of images generated is equal to a product value obtained by multiplying the number of parameter values corresponding to each category of the target parameters; and the third interface further displays a task submission control, and the providing the target parameter to a target generation model includes: providing the target parameter to the target generation model in response to the task submission control being triggered.

Optionally, the first interface further presents a task list that displays task information corresponding to a created task, and a result processing control for the created task; and the method further includes: adding, to the task list, task information corresponding to the target task, and a result processing control corresponding to the target task.

Optionally, the result processing control includes a result display sub-control and a result download sub-control; and the method further includes: displaying the target image on a fourth interface in response to a result display sub-control corresponding to the target task being triggered; and downloading the target image in response to a result download sub-control corresponding to the target task being triggered.

Optionally, the fourth interface displays a result comparison setting control; and the displaying the target image on a fourth interface includes: determining arrangement information of a plurality of target images by the result comparison setting control, and displaying the plurality of target images based on the arrangement information.

Optionally, the result comparison setting control includes a horizontal setting sub-control and a vertical setting sub-control; and the determining arrangement information of a plurality of target images by the result comparison setting control includes: determining at least one first comparison parameter from the target parameters by the horizontal setting sub-control, and determining at least one second comparison parameter from the target parameters by the vertical setting sub-control; and determining the arrangement information of the plurality of target images based on the first comparison parameter and the second comparison parameter, where a plurality of target images arranged in a same row correspond to a same second comparison parameter and different first comparison parameters; and a plurality of target images arranged in a same column correspond to a same first comparison parameter and different second comparison parameters.

Optionally, the fourth interface further displays a size adjustment control; and the displaying the target image on a fourth interface includes: determining size information of the target image by the size adjustment control, and displaying the target image based on the size information.

An embodiment of the present disclosure further provides an information processing apparatus. The apparatus includes: a first interface display module configured to display a first interface, where the first interface presents a task creation control; a second interface display module configured to display a second interface in response to the task creation control being triggered, where the second interface displays a task name setting control and a parameter setting control; an information obtaining module configured to obtain, by the task name setting control, a name of a target task to be performed, and obtain, by the parameter setting control, a target parameter corresponding to the target task, where there is at least one category of target parameters, and each category of the target parameters corresponds to at least one parameter value; and an image generation module configured to provide the target parameter to a target generation model causing the target generation model to generate a target image corresponding to the target task based on the target parameter, where a number of target images is determined based on a number of parameter values corresponding to each category of target parameters.

An embodiment of the present disclosure further provides an electronic device. The electronic device includes: a processor; and a memory, configured to store instructions executable by the processor, where the processor is configured to read the executable instructions from the memory, and execute the instructions to implement the information processing method provided in the embodiment of the present disclosure.

An embodiment of the present disclosure further provides a computer-readable storage medium having a computer program stored thereon, where the computer program is configured to perform the information processing method provided in the embodiment of the present disclosure.

It should be understood that the content described in this section is not intended to identify critical or important features of the embodiments of the present disclosure, and is not used to limit the scope of the present disclosure. Other features of the present disclosure will be easily understood by the following description.

### BRIEF DESCRIPTION OF THE DRAWINGS

The accompanying drawings herein, which are incorporated into and form a part of the description, illustrate the embodiments in line with the present disclosure and are used in conjunction with the description to explain the principles of the present disclosure.

In order to more clearly illustrate the technical solutions in the embodiments of the present disclosure or in the prior art, the accompanying drawings for describing the embodiments or the prior art will be briefly described below. Apparently, those of ordinary skill in the art may still derive other drawings from these accompanying drawings without creative efforts.

FIG. 1 is a schematic flowchart of an information processing method according to an embodiment of the present disclosure;

FIG. 2 is a schematic diagram of a first interface according to an embodiment of the present disclosure;

FIG. 3 is a schematic diagram of a second interface according to an embodiment of the present disclosure;

FIG. 4 is a schematic diagram of a second interface according to an embodiment of the present disclosure;

FIG. 5 is a schematic diagram of a target parameter list according to an embodiment of the present disclosure;

FIG. 6 is a diagram of a principle of determining the number of images generated according to an embodiment of the present disclosure;

FIG. 7 is a schematic diagram of a first interface according to an embodiment of the present disclosure;

FIG. 8 is a schematic diagram of a fourth interface according to an embodiment of the present disclosure;

FIG. 9 is a schematic diagram of a structure of an information processing apparatus according to an embodiment of the present disclosure; and

FIG. 10 is a schematic diagram of a structure of an electronic device according to an embodiment of the present disclosure.

### DETAILED DESCRIPTION OF EMBODIMENTS

For a clearer understanding of the above objectives, features and advantages of the present disclosure, the solutions of the present disclosure will be further described below. It should be noted that the embodiments of the present disclosure and features in the embodiments may be combined with each other without conflict.

Many specific details are set forth in the following description to facilitate a full understanding of the present disclosure. However, the present disclosure may also be implemented in other ways different from those described herein. Apparently, the embodiments in the description are only some rather than all of the embodiments of the present disclosure.

In the prior art, users often consume a lot of time and effort to obtain a plurality of images, which is inefficient. Relevant personnel need to set in turn a parameter required to perform a task, and each time a value of the parameter is set, the task needs to be executed once to obtain an image corresponding to the value of the parameter. Therefore, the user needs to spend time and effort to operate many times before a plurality of images can be obtained, which is inefficient. In order to mitigate the above problem, embodiments of the present disclosure provide an information processing method and apparatus, a device, and a medium, which are described in detail below.

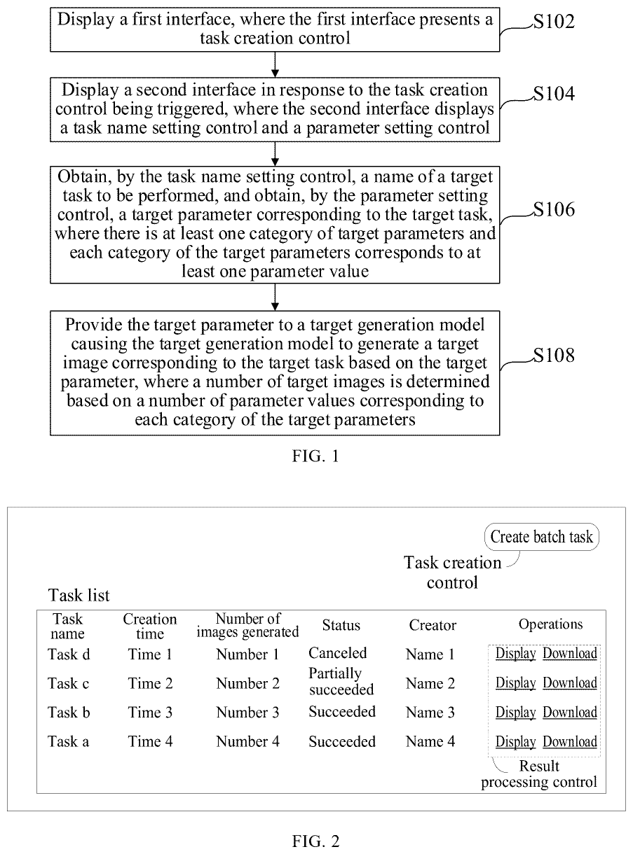

FIG. 1 is a schematic flowchart of an information processing method according to an embodiment of the present disclosure. The method may be performed by an information processing apparatus, which may be implemented using software and/or hardware and may generally be integrated into an electronic device. As shown in FIG. 1, the method mainly includes the following steps S102 to S108.

Step S102: Display a first interface, where the first interface presents a task creation control. In actual applications, the first interface may alternatively present other information content or controls, which is not limited herein.

Step S104: Display a second interface in response to the task creation control being triggered, where the second interface displays a task name setting control and a parameter setting control. In actual applications, the second interface may alternatively present other information content or controls, which is not limited herein.

Step S106: Obtain, by the task name setting control, a name of a target task to be performed, and obtain, by the parameter setting control, a target parameter corresponding to the target task, where there is at least one category of target parameters, and each category of the target parameters corresponds to at least one parameter value.

In this way, a user is allowed to easily and quickly set the task and the corresponding parameter, and to set different categories of target parameters at the same time, where each category of target parameters may correspond to one or more parameter values. As such, the user may not necessarily set only one parameter value at a time to perform the target task, and thus the efficiency of the user to set parameters can be improved greatly. The category of the target parameters is a custom category, for which a parameter category name may be set by the user. Alternatively, the categories of the target parameters may be represented by default as parameter 1, parameter 2, . . . , and parameter N, or the first parameter, the second parameter, . . . , and the N^{th} parameter according to a setting order of the target parameters. Each category of target parameters may include one independent parameter item or at least two parameter items (combined parameter items) with a correspondence. The above parameter items are parameter items required for the target task, such as a text parameter item used as a model prompt text, an image parameter item used as a model prompt image, a noise seed number parameter item used for constructing a noise map, and a step parameter item used as a model operating parameter. This is not limited herein. A specific value of a parameter item is a parameter value. For example, a parameter value of the text parameter item is text content, a parameter value of the image parameter item is a user input image, and a parameter value of the noise seed number is a specific value such as 1, 8, or 10. In the related technologies, the user can set only one parameter value for each parameter item. However, in embodiments of the present disclosure, the user is allowed to set a plurality of parameter values for each parameter item at a time.

Step S108: Provide the target parameter to a target generation model causing the target generation model to generate a target image corresponding to the target task based on the target parameter, where a number of target images is determined based on a number of parameter values corresponding to each category of target parameters. In actual applications, the target generation model may be a diffusion model, etc., for example, may be a text-to-image model or an image-to-image model, which is not limited herein. The target generation model may be a model set or specified by the user. Moreover, there may be one or more target generation models. Different target generation models have different structures or parameters. The target parameter may be provided to one or more specified target generation models simultaneously, so that there is no need to perform parameter setting for each target generation model, thereby improving the image generation efficiency.

There is at least one category of target parameters that can be set by the user, and each category of the target parameters corresponds to at least one parameter value, and then the obtained target parameter is provided to the target generation model. Therefore, when one or more parameter values corresponding to different categories of target parameters are combined, a plurality of target images can be obtained quickly and easily by using the target generation model. Specifically, the number of target images is equal to a product value of the numbers of parameter values corresponding to different categories of target parameters. For example, it is assumed that a total of two categories of target parameters are set, namely, a target parameter 1 and a target parameter 2. The number of parameter values corresponding to parameter 1 is 5, the number of parameter values corresponding to parameter 2 is 6. Then, the target parameter 1 and the target parameter 2 are both provided to the target generation model. The target generation model can generate 30 images with different effects based on a combination of the target parameter 1 and the target parameter 2. However, in the related technologies, in order to implement the above effect, the user is required to perform parameter setting 30 times separately to obtain 30 images generated, with one image generated by the model after each parameter setting.

In this way, the image generation efficiency can be greatly improved, and the labor and time costs for obtaining a plurality of target images can be reduced.

In actual applications, to facilitate the user to conveniently view tasks that currently exist, in addition to showing the task creation control, the first interface further presents a task list. Reference may be made to FIG. 2, which is a schematic diagram of a first interface. In this figure, the first interface further presents a task list that displays task information corresponding to created tasks and result processing controls for the created tasks. For example, the task information includes a task name, a creation time, the number of images generated, a status, a creator, and corresponding result processing controls, where the result processing controls may specifically include a result display sub-control and a result download sub-control. The user may view or download a corresponding image generation result based on a created task, and the result is not limited to images generated, but may further include information such as an execution file corresponding to the task and a set target parameter. It should be noted that FIG. 2 is merely used as an example for illustration, and in actual applications, the task list may not be presented or may include more or less task information than that shown in FIG. 2, or even the first interface may present other content. This is not limited herein.

If the user needs to create a task, the task creation control may be triggered to jump to the second interface. The user may set a name of the newly created target task by the task name setting control on the second interface, and may further set a target parameter corresponding to the target task by the parameter setting control. In actual applications, the task name setting control may also display a default name, and if the user does not trigger the task name setting control to modify the default name, the default name may be used as the name of the target task.

In some specific embodiments, the parameter setting control includes a parameter addition sub-control, a parameter category setting sub-control, a parameter type selection sub-control, and a parameter information setting sub-control. Therefore, the step of obtaining, by the parameter setting control, a target parameter corresponding to the target task may be performed with reference to the following steps a to c.

Step a: Display, in response to the parameter addition sub-control being triggered, a parameter category setting sub-control, a parameter type selection sub-control, and a parameter information setting sub-control that correspond to a parameter to be added, where the parameter to be added is a target parameter to be set.

Step b: Determine, by the parameter category setting sub-control, a parameter category name corresponding to the parameter to be added, and determine, by the parameter type selection sub-control, a parameter type corresponding to the parameter to be added, where the parameter category name is a custom name, and the parameter type includes a single-parameter type or a combined parameter type.

For example, the parameter category setting sub-control is used to instruct the user to fill in a custom parameter category name for the target parameter to be set. In some specific embodiments, the parameter category setting sub-control may also display a default category name, for example, parameter 1, parameter 2, . . . , parameter N, etc., and if the user does not trigger the parameter type selection sub-control, the default name is used as the category name of the parameter to be added. The single-parameter type means that the parameter to be added includes only an independent parameter item, and the parameter item is not bundled or associated with another parameter item. The combined parameter type means that the parameter to be added includes at least two parameter items with a correspondence. The at least two parameter items with a correspondence may be considered to be in a bundling relationship. It is assumed that the parameter type of the parameter to be added is the combined parameter type, and the parameter to be added includes a parameter item a and a parameter item b with a correspondence, that is, the parameter item a and the parameter item b are a combined parameter, and parameter values of the parameter item a and the parameter item b are in one-to-one correspondence and are the same in number. For example, the parameter item a has three parameter values which are respectively a1, a2, and a3, and the parameter item b has three parameter values which are respectively b1, b2, and b3, indicating that a1 corresponds to b1, a2 corresponds to b2, and a3 corresponds to b3. In this case, it may be considered that the parameter to be added has a total of three combined parameter values which are a1-b1, a2-b2, and a3-b3, respectively.

Step c: Display, based on the parameter type corresponding to the parameter to be added, the parameter information setting sub-control corresponding to the parameter to be added, obtain, by the parameter information setting sub-control corresponding to the parameter to be added, parameter information of the parameter to be added, and determine the target parameter corresponding to the target task based on the parameter information of the parameter to be added. The parameter information includes, but is not limited to, a name of the parameter item and a parameter value corresponding to the parameter item. Specifically, the obtained parameter information of the parameter to be added may be directly used as the target parameter corresponding to the target task. In this way, the parameter information of the target parameter that the user needs to set can be easily and quickly obtained. The parameter information setting sub-control supports setting of one or more parameter items, and each parameter item supports setting of more than one parameter value. It should be noted that, in actual applications, the parameter items and the parameter values are in one-to-one correspondence. In embodiments of the present disclosure, the user is supported to set a plurality of parameter values for one parameter item at a time. This does not indicate that the parameter item takes the plurality of parameter values at a time, but indicates that the parameter item can take each of the plurality of parameter values in turn and the parameter value may be combined with a parameter value of another parameter item. In addition, the user may perform steps a to c multiple times according to requirements, so that a plurality of categories of target parameters can be set.

In some specific embodiments, the parameter information setting sub-controls vary with different parameter types. For example, the displaying, based on the parameter type corresponding to the parameter to be added, the parameter information setting sub-control corresponding to the parameter to be added includes: displaying a first parameter information setting sub-control for setting an independent parameter item when the parameter type corresponding to the parameter to be added is the single-parameter type; or displaying a second parameter information setting sub-control for setting at least two parameter items with a correspondence (bundling relationship) when the parameter type corresponding to the parameter to be added is the combined parameter type. In other words, the first parameter information setting sub-control is used only to support setting of the independent parameter item and indicate setting of parameter value for the independent parameter item; and the second parameter information setting sub-control is used to support setting of at least two parameter items with a correspondence, indicate setting of parameter values for the at least two parameter items with a correspondence, and restrict the parameter values of the at least two parameter items with the bundling relationship to be in one-to-one correspondence, that is, to be in a mapping relationship.

In some specific embodiments, the parameter information setting sub-control includes a parameter item setting sub-control and a parameter value setting sub-control; and the obtaining, by the parameter information setting sub-control corresponding to the parameter to be added, parameter information of the parameter to be added includes: displaying a parameter item list by the parameter item setting sub-control, and obtaining, based on a selection operation for the parameter item list, a parameter item of the parameter to be added, where parameter items in the parameter item list are read from an execution tool of the target task, and each category of parameters to be added corresponds to at least one parameter item; and obtaining, by the parameter value setting sub-control, at least one parameter value corresponding to the parameter item of the parameter to be added. The target task may be specifically an image generation task, which is specifically to generate images by using a neural network model. The embodiments of the present disclosure do not limit an execution tool of the target task, which may also be referred to as execution software or an execution system. In actual applications, the information processing method according to the embodiments of the present disclosure may be implemented by using target software, where the target software has an interactive interface with the execution tool of the target task. Each logical node (namely, task execution node) executing the target task and a parameter item corresponding to each logical node may be read from the execution tool of the target task. Thus, all the logical nodes read, and the corresponding parameter items can be presented in the parameter item list. The user may directly drop down the parameter item list to select the parameter item of the parameter to be added, or may select the parameter item of the parameter to be added from the parameter item list through a fuzzy search. In this way, the user is allowed to quickly and easily determine the parameter item that can be set to perform the target task, and it can be effectively ensured that the parameter item set by the user matches the target task.

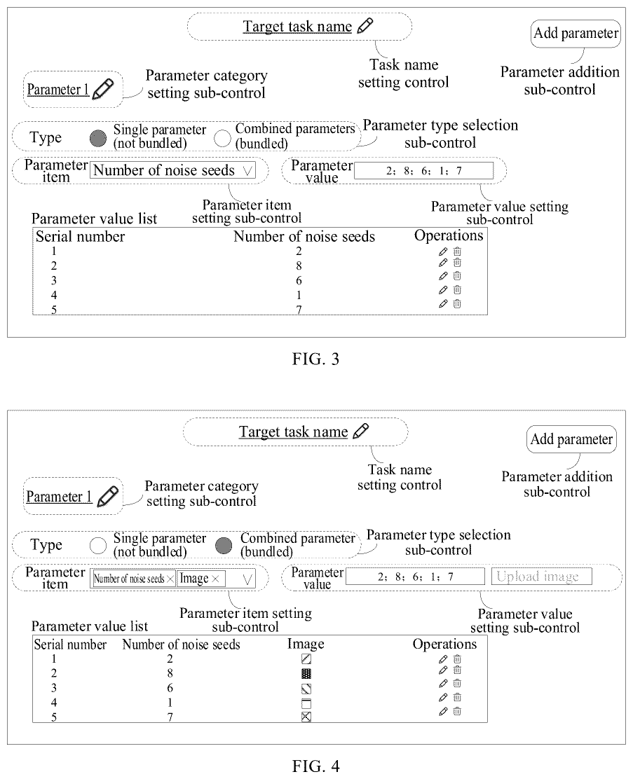

For ease of understanding, reference may be made to FIG. 3 and FIG. 4 each being a schematic diagram of a second interface, and showing a task name setting control, a parameter addition sub-control, a parameter category setting sub-control, a parameter type selection sub-control, a parameter item setting sub-control, and a parameter value setting sub-control. For ease of viewing by the user, a parameter value list is also clearly shown. A plurality of parameter values corresponding to parameter items are displayed in the parameter value list, which may be further modified or deleted by the user. The above description is merely an example. In actual applications, the user may alternatively operate in the parameter value setting sub-control to modify/delete a set parameter value directly. This is not limited herein. In addition, the parameter value setting sub-control supports batch filling of a plurality of parameter values, and different parameter values are separated by specific symbols (for example, semicolons). FIG. 3 shows the case where the parameter to be added is of a single-parameter type. The parameter item setting sub-control and the parameter value setting sub-control in FIG. 3 jointly correspond to the first parameter information setting sub-control described above. FIG. 4 shows the case where the parameter to be added is of a combined parameter type. The parameter item setting sub-control and the parameter value setting sub-control in FIG. 4 jointly correspond to the second parameter information setting sub-control described above. In FIG. 4, noise seed number parameter values and image parameter values (for example, prompt images of a model) are in one-to-one mapping relationship. The specific mapping relationship may be determined based on the order of parameter values set by the user for the two parameter items, and can be modified and adjusted subsequently by the user, which is not limited herein. It should be noted that FIG. 3 and FIG. 4 are illustrative and should not be considered limiting. In actual applications, the types of controls included in the layout or interface may be flexibly changed.

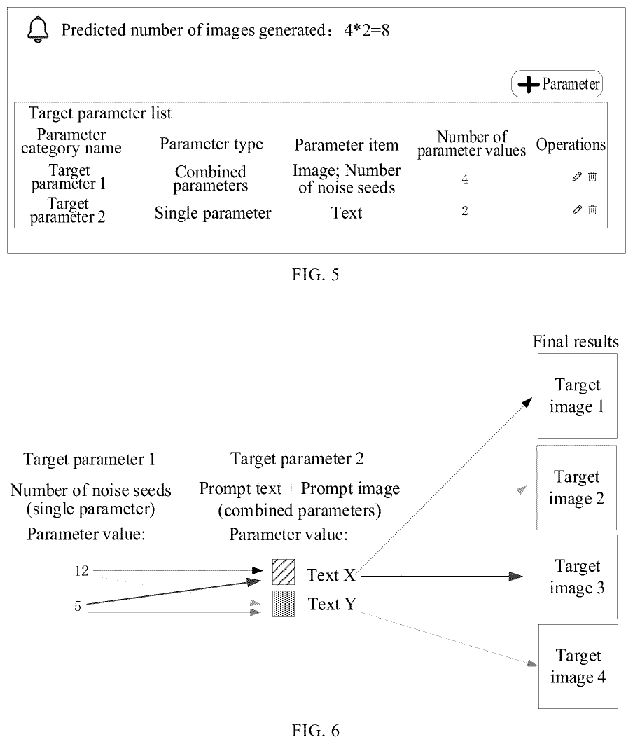

After setting of the target parameter is completely finished, a target parameter list and a predicted number of images generated may be displayed on a third interface, where the target parameter list is used to present parameter information of the target parameter and a modify control corresponding to the target parameter, the predicted number of images generated is a predicted number of target images that are obtained by performing the target task based on the target parameter, and the predicted number of images generated is equal to a product value obtained by multiplying the number of parameter values corresponding to each category of target parameters. The third interface further displays a task submission control, and the providing the target parameter to a target generation model includes: providing the target parameter to the target generation model in response to the task submission control being triggered. For ease of understanding, reference may be made to FIG. 5, which is a schematic diagram of a target parameter list. The target parameter list can clearly present target parameters that have been set so far, and corresponding parameter information. The user may further add or modify the set target parameters, which provides the user with great convenience.

For ease of understanding of a calculation principle of the expected image generation number, reference may be made to FIG. 6 for the principle of determining the number of images generated. For example, there are a target parameter 1 and a target parameter 2, the target parameter 1 is of a single-parameter type and has two parameter values, and the target parameter 2 is of a combined parameter type and has two bundled parameter values, that is, has two parameter values each are a text and an image corresponding to each other. In this case, when the parameter values of the target parameter 1 and the target parameter 2 are combined, four groups of parameter values may be obtained. The four groups of parameter values are provided to a model, so that the model can perform image generation processing based on the four groups of parameter values, to obtain four target images.

Through the above method, the user can set, at a time, a plurality of categories of target parameters required to perform the target task and a plurality of parameter values of parameter items corresponding to each category of target parameters, the plurality of parameter values of the plurality of categories of target parameters are combined and provided to the model together. As such, the model can efficiently perform the target task based on a plurality of combination of parameter values, thereby achieving batch generation of images. In addition, the target images with different effects may be obtained based on different combinations of parameter values, thereby better implementing material expansion or effect comparison.

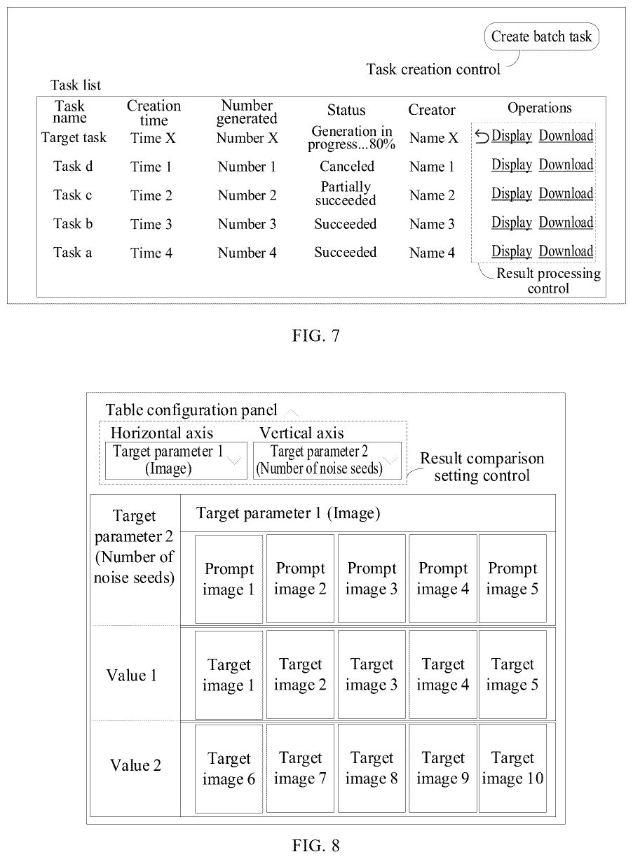

The above method further includes: adding, to the task list, task information corresponding to the target task, and a result processing control corresponding to the target task. For ease of understanding, reference may be further made again to FIG. 7, which is a schematic diagram of a first interface. On this first interface, task information corresponding to a target task is added on the basis of FIG. 2, where a status corresponding to the target task indicates that the task is in the progress of generating images, and further displays the progress of task execution to enable the user to clearly understand the execution of the task. Further, the user may cancel the execution of the task, and return to the parameter setting interface for this task to modify a parameter of the task. This is not limited herein.

On the basis that the result processing control includes a result display sub-control and a result download sub-control, the above method further includes: displaying the target image on a fourth interface in response to a result display sub-control corresponding to the target task being triggered; and downloading the target image in response to a result download sub-control corresponding to the target task being triggered. In addition, the result processing control may further include a parameter copying sub-control for directly obtaining all target parameters corresponding to the target task, and a file obtaining sub-control for obtaining an execution file of the target task.

In some embodiments, the fourth interface displays a result comparison setting control; and the displaying the target image on a fourth interface includes: determining arrangement information of a plurality of target images by the result comparison setting control, and displaying the plurality of target images based on the arrangement information.

In some specific embodiments, the result comparison setting control includes a horizontal setting sub-control and a vertical setting sub-control; and the determining arrangement information of a plurality of target images by the result comparison setting control includes: determining at least one first comparison parameter from the target parameters by the horizontal setting sub-control, and determining at least one second comparison parameter from the target parameters by the vertical setting sub-control; and determining the arrangement information of the plurality of target images based on the first comparison parameter and the second comparison parameter, where a plurality of target images arranged in a same row correspond to a same second comparison parameter and different first comparison parameters; and a plurality of target images arranged in a same column correspond to a same first comparison parameter and different second comparison parameters. Specifically, when there are a plurality of categories of target parameters, at least two categories of target parameters may be selected from the plurality of categories of target parameters as the first comparison parameter and the second comparison parameter, so that the user can visually view the image generation effect achieved by a combination of different categories of target parameters.

For ease of understanding, reference may be further made to FIG. 8, which is a schematic diagram of a fourth interface. In this figure, a table configuration panel is expanded to show a result comparison setting control, in which a horizontal axis control corresponds to the above horizontal setting sub-control, and a vertical axis control corresponds to the above vertical setting sub-control. The two sub-controls each can present set target parameters to the user in the form of a drop-down list, from which the user may select a first comparison parameter and a second comparison parameter according to requirements. For example, in FIG. 8, the first comparison parameter corresponding to the horizontal axis is image, which item has five parameter values, namely, prompt image 1 to prompt image 5, and the second comparison parameter corresponding to the vertical axis is number of noise seeds, which has two parameter values, namely, value 1 and the value 2. Ten target images corresponding to different combinations of the parameter values of the target parameter 1 and the target parameter 2 are shown in the table of FIG. 8, so that the user can clearly view an image generation effect corresponding to each combination of the parameter values, and know clearly, for a same parameter value, a difference in target images generated when the parameter value is combined with different parameter values of other parameter items, which helps the user to efficiently and reliably determine, from the parameter values, the exact parameter value corresponding to the target task.

Moreover, the fourth interface further displays a size adjustment control; and the displaying the target image on a fourth interface includes: determining size information of the target image by the size adjustment control, and displaying the target image based on the size information. For example, the size adjustment control may be presented in the form of a slide bar, which is not limited herein. The size adjustment control allows the user to zoom in or out the target image according to requirements, improving the flexibility.

In conclusion, according to the information processing method provided in the embodiments of the present disclosure, the image generation efficiency can be effectively improved, and the labor and time costs for obtaining a plurality of target images can be reduced.

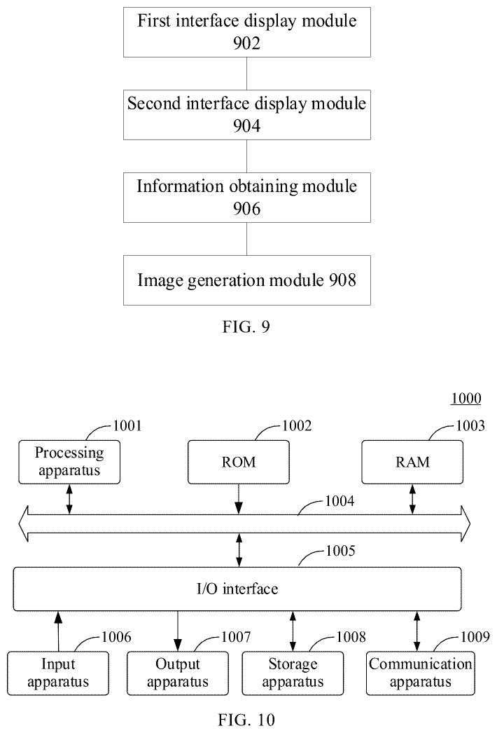

Corresponding to the above information processing method, an embodiment of the present disclosure further provides an information processing apparatus. FIG. 9 is a schematic diagram of a structure of the information processing apparatus according to this embodiment of the present disclosure. The apparatus may be implemented by software and/or hardware, and may generally be integrated in an electronic device. As shown in FIG. 9, the information processing apparatus includes:
a first interface display module 902 configured to display a first interface, where the first interface presents a task creation control;
a second interface display module 904 configured to display a second interface in response to the task creation control being triggered, where the second interface displays a task name setting control and a parameter setting control;
an information obtaining module 906 configured to obtain, by the task name setting control, a name of a target task to be performed, and obtain, by the parameter setting control, a target parameter corresponding to the target task, where there is at least one category of target parameters, and each category of the target parameters corresponds to at least one parameter value;
an image generation module 908 configured to provide the target parameter to a target generation model causing the target generation model to generate a target image corresponding to the target task based on the target parameter, where a number of target images is determined based on a number of parameter values corresponding to each category of target parameters.

According to the above apparatus provided in the embodiment of the present disclosure, the user can conveniently create a desired target task and set the corresponding target parameter by controls on the interface, where there is at least one category of settable target parameters, and each category of the target parameters corresponds to at least one parameter value; and then, the obtained target parameter is provided to the target generation model causing the target generation model to generate the target image corresponding to the target task based on the target parameter, where the number of target images is determined based on the number of parameter values corresponding to each category of target parameters. When one or more parameter values corresponding to different categories of target parameters are combined, a plurality of target images can be quickly and easily obtained by using the target generation model. By the above apparatus, the efficiency of image generation can be greatly improved, and the labor and time costs for obtaining a plurality of target images can be reduced.

In some implementations, the parameter setting control includes a parameter addition sub-control, a parameter category setting sub-control, a parameter type selection sub-control, and a parameter information setting sub-control; and the information obtaining module 906 is specifically configured to: display, in response to the parameter addition sub-control being triggered, a parameter category setting sub-control, a parameter type selection sub-control, and a parameter information setting sub-control that correspond to a parameter to be added; determine, by the parameter category setting sub-control, a parameter category name corresponding to the parameter to be added, and determine, by the parameter type selection sub-control, a parameter type corresponding to the parameter to be added, where the parameter category name is a custom name, and the parameter type includes a single-parameter type or a combined parameter type; and display, based on the parameter type corresponding to the parameter to be added, the parameter information setting sub-control corresponding to the parameter to be added, obtain, by the parameter information setting sub-control corresponding to the parameter to be added, parameter information of the parameter to be added, and determine the target parameter corresponding to the target task based on the parameter information of the parameter to be added.

In some implementations, the information obtaining module 906 is specifically configured to: display a first parameter information setting sub-control for setting an independent parameter item to be added, when the parameter type corresponding to the parameter to be added is the single-parameter type; or display a second parameter information setting sub-control for setting at least two parameter items to be added that have a correspondence, when the parameter type corresponding to the parameter to be added is the combined parameter type.

In some implementations, the parameter information setting sub-control includes a parameter item setting sub-control and a parameter value setting sub-control; and the information obtaining module 906 is specifically configured to: display a parameter item list by the parameter item setting sub-control, and obtain, based on a selection operation for the parameter item list, a parameter item of the parameter to be added, where parameter items in the parameter item list are read from an execution tool of the target task, and each category of parameters to be added corresponds to at least one parameter item; and obtain, by the parameter value setting sub-control, at least one parameter value corresponding to the parameter item of the parameter to be added.

In some implementations, the apparatus further includes a third interface display module configured to display, on a third interface, a target parameter list and a predicted number of images generated, where the target parameter list is used to present parameter information of the target parameter and a modify control corresponding to the target parameter, the predicted number of images generated is a predicted number of target images that are obtained by performing the target task based on the target parameter, and the predicted number of images generated is equal to a product value obtained by multiplying the number of parameter values corresponding to each category of target parameters.

In some implementations, the third interface further displays a task submission control, and the image generation module 908 is specifically configured to provide the target parameter to the target generation model in response to the task submission control being triggered.

In some implementations, the first interface further presents a task list that displays task information corresponding to a created task and a result processing control for the created task; and the apparatus further includes a list addition module configured to add, to the task list, task information corresponding to the target task, and a result processing control corresponding to the target task.

In some implementations, the result processing control includes a result display sub-control and a result download sub-control; and the apparatus further includes a fourth interface display module configured to: display the target image on a fourth interface in response to a result display sub-control corresponding to the target task being triggered; and download the target image in response to a result download sub-control corresponding to the target task being triggered.

In some implementations, the fourth interface displays a result comparison setting control; and the fourth interface display module is specifically configured to determine arrangement information of a plurality of target images by the result comparison setting control, and display the plurality of target images based on the arrangement information.

In some implementations, the result comparison setting control includes a horizontal setting sub-control and a vertical setting sub-control; and the fourth interface display module is specifically configured to: determine at least one first comparison parameter from the target parameters by the horizontal setting sub-control, and determine at least one second comparison parameter from the target parameters by the vertical setting sub-control; and determine the arrangement information of the plurality of target images based on the first comparison parameter and the second comparison parameter, where a plurality of target images arranged in a same row correspond to a same second comparison parameter and different first comparison parameters; and a plurality of target images arranged in a same column correspond to a same first comparison parameter and different second comparison parameters.

In some implementations, the fourth interface further displays a size adjustment control; and the fourth interface display module is specifically configured to determine size information of the target image by the size adjustment control, and display the target image based on the size information.

The information processing apparatus provided in this embodiment of the present disclosure can perform the information processing method provided in any one of the embodiments of the present disclosure, and has corresponding functional modules and beneficial effects for performing the method.

It can be clearly understood by those skilled in the art that, for convenience and brevity of description, for the specific operation processes of the apparatus embodiment described above, reference may be made to the corresponding processes in the foregoing method embodiments, and details are not described herein again.

An embodiment of the present disclosure further provides an electronic device. The electronic device includes: a storage apparatus having a computer program stored thereon; and a processing apparatus configured to execute the computer program in the storage apparatus to implement the steps of any one of the methods according to the present disclosure.

Reference is made to FIG. 10 below, which is a schematic diagram of a structure of an electronic device 1000 suitable for implementing an embodiment of the present disclosure. A terminal device in this embodiment of the present disclosure may include, but is not limited to, mobile terminals such as a mobile phone, a notebook computer, a digital broadcast receiver, a personal digital assistant (PDA), a tablet computer (portable Android device, PAD), a portable media player (PMP), and a vehicle-mounted terminal (e.g., a vehicle navigation terminal), and fixed terminals such as a digital TV and a desktop computer. The electronic device shown in FIG. 10 is merely an example, and shall not impose any limitation on the function and scope of use of the embodiments of the present disclosure.

As shown in FIG. 10, the electronic device 1000 may include a processing apparatus (for example, a central processing unit or a graphics processing unit) 1001 that may perform a variety of appropriate actions and processing in accordance with a program stored in a read-only memory (ROM) 1002 or a program loaded from a storage apparatus 1008 into a random-access memory (RAM) 1003. The RAM 1003 further stores various programs and data required for the operation of the electronic device 1000. The processing apparatus 1001, the ROM 1002, and the RAM 1003 are connected to one another through a bus 1004. An input/output (I/O) interface 1005 is also connected to the bus 1004.

Generally, the following apparatuses may be connected to the I/O interface 1005: an input apparatus 1006 including, for example, a touchscreen, a touchpad, a keyboard, a mouse, a camera, a microphone, an accelerometer, and a gyroscope; an output apparatus 1007 including, for example, a liquid crystal display (LCD), a speaker, and a vibrator; the storage apparatus 1008 including, for example, a tape and a hard disk; and a communication apparatus 1009. The communication apparatus 1009 may allow the electronic device 1000 to perform wireless or wired communication with other devices to exchange data. Although FIG. 10 shows the electronic device 1000 having various apparatuses, it should be understood that it is not required to implement or have all of the shown apparatuses. It may be an alternative to implement or have more or fewer apparatuses.

In particular, according to an embodiment of the present disclosure, the process described above with reference to the flowchart may be implemented as a computer software program. For example, an embodiment of the present disclosure includes a computer program product, which includes a computer program carried on a non-transitory computer-readable medium, where the computer program includes program code for performing the method shown in the flowchart. In such an embodiment, the computer program may be downloaded and installed from a network by the communication apparatus 1009, installed from the storage apparatus 1008, or installed from the ROM 1002. When the computer program is executed by the processing apparatus 1001, the above functions defined in the method of the embodiment of the present disclosure are performed.

In addition to the above method and device, an embodiment of the present disclosure may further be a computer program product including computer program instructions that, when run by a processor, cause the processor to perform the information processing method provided in the embodiment of the present disclosure. In the computer program product, program code for performing the operations of the embodiments of the present disclosure may be written in any combination of one or more programming languages, where the programming languages include an object-oriented programming language, such as Java, and C++, and further include conventional procedural programming languages, such as “C” language or similar programming languages. The program code may be completely executed on a user computing device, partially executed on a user device, executed as an independent software package, executed partially on a user computing device and partially on a remote computing device, or completely executed on a remote computing device or a server.

In addition, an embodiment of the present disclosure may further be a computer-readable storage medium having computer program instructions stored thereon, where the computer program instructions, when run by a processor, cause the processor to perform the information processing method provided in the embodiment of the present disclosure.

The computer-readable storage medium may be any combination of one or more readable media. The readable medium may be a readable signal medium or a readable storage medium. The readable storage medium may include, for example, but not limited to, an electronic, magnetic, optical, electromagnetic, infrared, or semiconductor system, apparatus, or device, or any combination thereof. More specific examples of the readable storage media (a non-exhaustive list) include: an electrical connection having one or more wires, a portable disk, a hard disk, a random-access memory (RAM), a read-only memory (ROM), an erasable programmable read-only memory (EPROM or flash), an optic fiber, a portable compact disk read-only memory (CD-ROM), an optical storage device, a magnetic storage device, or any suitable combination thereof.

An embodiment of the present disclosure further provides a computer program product, including a computer program/instruction that, when executed by a processor, implement the information processing method in the embodiments of the present disclosure.

It can be understood that before the use of the technical solutions disclosed in the embodiments of the present disclosure, the user shall be informed of the type, range of use, use scenarios, etc. of personal information involved in the present disclosure in an appropriate manner in accordance with the relevant laws and regulations, and the authorization of the user shall be obtained.

For example, in response to reception of an active request from the user, prompt information is sent to the user to clearly inform the user that a requested operation will require access to and use of the personal information of the user. As such, the user can independently choose, based on the prompt information, whether to provide the personal information to software or hardware, such as an electronic device, an application, a server, or a storage medium, that performs operations in the technical solutions of the present disclosure.

As an optional but non-limiting implementation, in response to the reception of the active request from the user, the prompt information may be sent to the user in the form of, for example, a pop-up window, in which the prompt information may be presented in text. Furthermore, the pop-up window may further include a selection control for the user to choose whether to “agree” or “disagree” to provide the personal information to the electronic device.

It can be understood that the above process of notifying and obtaining user authorization is only illustrative and does not constitute a limitation on the implementations of the present disclosure, and other manners that satisfy the relevant laws and regulations may also be applied in the implementations of the present disclosure.

It should be noted that the relational terms such as “first” and “second” herein are only used to distinguish one entity or operation from another, and do not necessarily require or imply that any actual relationship or sequence exists between these entities or operations. Moreover, the terms “include” and “comprise”, or any of their variants are intended to cover a non-exclusive inclusion, so that a process, method, article, or device that includes a list of elements not only includes those elements but also includes other elements that are not expressly listed, or further includes elements inherent to such process, method, article, or device. In the absence of more restrictions, an element defined by “including/comprising a/an . . . ” does not exclude another identical element in a process, method, article, or device that includes the element.

The above description illustrates merely specific implementations of the present disclosure, so that those skilled in the art can understand or implement the present disclosure. Various modifications to these embodiments are apparent to those skilled in the art, and the general principle defined herein may be practiced in other embodiments without departing from the spirit or scope of the present disclosure. Therefore, the present disclosure will not be limited to the embodiments described herein, but extends to the widest scope that complies with the principles and novelty disclosed in this specification.

I/We claim:

1. An information processing method, comprising:
displaying a first interface, wherein the first interface presents a task creation control;
displaying a second interface in response to the task creation control being triggered, wherein the second interface displays a task name setting control and a parameter setting control;
obtaining, by the task name setting control, a name of a target task to be performed, and obtaining, by the parameter setting control, a target parameter corresponding to the target task, wherein there is at least one category of target parameters, and each category of the target parameters corresponds to at least one parameter value; and
providing the target parameter to a target generation model causing the target generation model to generate a target image corresponding to the target task based on the target parameter, wherein a number of target images is determined based on a number of parameter values corresponding to each category of the target parameters.

2. The method according to claim 1, wherein the parameter setting control comprises a parameter addition sub-control, a parameter category setting sub-control, a parameter type selection sub-control, and a parameter information setting sub-control; and the obtaining, by the parameter setting control, a target parameter corresponding to the target task comprises:
displaying, in response to the parameter addition sub-control being triggered, a parameter category setting sub-control, a parameter type selection sub-control, and a parameter information setting sub-control that correspond to a parameter to be added;
determining, by the parameter category setting sub-control, a parameter category name corresponding to the parameter to be added, and determining, by the parameter type selection sub-control, a parameter type corresponding to the parameter to be added, wherein the parameter category name is a custom name, and the parameter type comprises a single-parameter type or a combined parameter type; and
displaying, based on the parameter type corresponding to the parameter to be added, the parameter information setting sub-control corresponding to the parameter to be added, obtaining, by the parameter information setting sub-control corresponding to the parameter to be added, parameter information of the parameter to be added, and determining the target parameter corresponding to the target task based on the parameter information of the parameter to be added.

3. The method according to claim 2, wherein the displaying, based on the parameter type corresponding to the parameter to be added, the parameter information setting sub-control corresponding to the parameter to be added comprises:
displaying a first parameter information setting sub-control for setting an independent parameter item in response to the parameter type corresponding to the parameter to be added being the single-parameter type; or
displaying a second parameter information setting sub-control for setting at least two parameter items with a correspondence in response to the parameter type corresponding to the parameter to be added being the combined parameter type.

4. The method according to claim 2, wherein the parameter information setting sub-control comprises a parameter item setting sub-control and a parameter value setting sub-control; and the obtaining, by the parameter information setting sub-control corresponding to the parameter to be added, parameter information of the parameter to be added comprises:
displaying a parameter item list by the parameter item setting sub-control, and obtaining, based on a selection operation for the parameter item list, a parameter item of the parameter to be added, wherein parameter items in the parameter item list are read from an execution tool of the target task, and each category of parameters to be added corresponds to at least one parameter item; and
obtaining, by the parameter value setting sub-control, at least one parameter value corresponding to the parameter item of the parameter to be added.

5. The method according to claim 1, wherein the method further comprises:
displaying, on a third interface, a target parameter list and a predicted number of images generated, wherein the target parameter list is used to present parameter information of the target parameter and a modify control corresponding to the target parameter, the predicted number of images generated is a predicted number of target images that are obtained by performing the target task based on the target parameter, and the predicted number of images generated is equal to a product value obtained by multiplying the number of parameter values corresponding to each category of the target parameters; and
the third interface further displays a task submission control, and the providing the target parameter to a target generation model comprises: providing the target parameter to the target generation model in response to the task submission control being triggered.

6. The method according to claim 1, wherein the first interface further presents a task list that displays task information corresponding to a created task, and a result processing control for the created task; and
the method further comprises:
adding, to the task list, task information corresponding to the target task and a result processing control corresponding to the target task.

7. The method according to claim 6, wherein the result processing control comprises a result display sub-control and a result download sub-control; and
the method further comprises:
displaying the target image on a fourth interface in response to a result display sub-control corresponding to the target task being triggered; and
downloading the target image in response to a result download sub-control corresponding to the target task being triggered.

8. The method according to claim 7, wherein the fourth interface displays a result comparison setting control; and the displaying the target image on a fourth interface comprises:
determining arrangement information of a plurality of target images by the result comparison setting control, and displaying the plurality of target images based on the arrangement information.

9. The method according to claim 8, wherein the result comparison setting control comprises a horizontal setting sub-control and a vertical setting sub-control; and the determining arrangement information of a plurality of target images by the result comparison setting control comprises:
determining at least one first comparison parameter from the target parameters by the horizontal setting sub-control, and determining at least one second comparison parameter from the target parameters by the vertical setting sub-control; and
determining the arrangement information of the plurality of target images based on the first comparison parameter and the second comparison parameter, wherein a plurality of target images arranged in a same row correspond to a same second comparison parameter and different first comparison parameters; and a plurality of target images arranged in a same column correspond to a same first comparison parameter and different second comparison parameters.

10. The method according to claim 7, wherein the fourth interface further displays a size adjustment control; and the displaying the target image on a fourth interface comprises:
determining size information of the target image by the size adjustment control, and displaying the target image based on the size information.

11. An electronic device, comprising:
a memory having instructions stored thereon; and
a processor configured to execute the instructions in the memory, to:
display a first interface, wherein the first interface presents a task creation control;
display a second interface in response to the task creation control being triggered, wherein the second interface displays a task name setting control and a parameter setting control;
obtain, by the task name setting control, a name of a target task to be performed, and obtain, by the parameter setting control, a target parameter corresponding to the target task, wherein there is at least one category of target parameters, and each category of the target parameters corresponds to at least one parameter value; and
provide the target parameter to a target generation model causing the target generation model to generate a target image corresponding to the target task based on the target parameter, wherein a number of target images is determined based on a number of parameter values corresponding to each category of the target parameters.

12. The device according to claim 11, wherein the parameter setting control comprises a parameter addition sub-control, a parameter category setting sub-control, a parameter type selection sub-control, and a parameter information setting sub-control; and the instructions causing the processor to obtain, by the parameter setting control, a target parameter corresponding to the target task comprise instructions causing the processor to:
display, in response to the parameter addition sub-control being triggered, a parameter category setting sub-control, a parameter type selection sub-control, and a parameter information setting sub-control that correspond to a parameter to be added;
determine, by the parameter category setting sub-control, a parameter category name corresponding to the parameter to be added, and determine, by the parameter type selection sub-control, a parameter type corresponding to the parameter to be added, wherein the parameter category name is a custom name, and the parameter type comprises a single-parameter type or a combined parameter type; and
display, based on the parameter type corresponding to the parameter to be added, the parameter information setting sub-control corresponding to the parameter to be added, obtaining, by the parameter information setting sub-control corresponding to the parameter to be added, parameter information of the parameter to be added, and determine the target parameter corresponding to the target task based on the parameter information of the parameter to be added.

13. The device according to claim 12, wherein the instructions causing the processor to display, based on the parameter type corresponding to the parameter to be added, the parameter information setting sub-control corresponding to the parameter to be added comprise instructions causing the processor to:
display a first parameter information setting sub-control for setting an independent parameter item in response to the parameter type corresponding to the parameter to be added being the single-parameter type; or
display a second parameter information setting sub-control for setting at least two parameter items with a correspondence in response to the parameter type corresponding to the parameter to be added being the combined parameter type.

14. The device according to claim 12, wherein the parameter information setting sub-control comprises a parameter item setting sub-control and a parameter value setting sub-control; and the instructions causing the processor to obtain, by the parameter information setting sub-control corresponding to the parameter to be added, parameter information of the parameter to be added comprise instructions causing the processor to:
display a parameter item list by the parameter item setting sub-control, and obtain, based on a selection operation for the parameter item list, a parameter item of the parameter to be added, wherein parameter items in the parameter item list are read from an execution tool of the target task, and each category of parameters to be added corresponds to at least one parameter item; and
obtain, by the parameter value setting sub-control, at least one parameter value corresponding to the parameter item of the parameter to be added.

15. The device according to claim 11, wherein the device is further caused to:
display, on a third interface, a target parameter list and a predicted number of images generated, wherein the target parameter list is used to present parameter information of the target parameter and a modify control corresponding to the target parameter, the predicted number of images generated is a predicted number of target images that are obtained by performing the target task based on the target parameter, and the predicted number of images generated is equal to a product value obtained by multiplying the number of parameter values corresponding to each category of the target parameters; and
the third interface further displays a task submission control, and the instructions causing the processor to provide the target parameter to a target generation model comprise instructions causing the processor to: providing the target parameter to the target generation model in response to the task submission control being triggered.

16. The device according to claim 11, wherein the first interface further presents a task list that displays task information corresponding to a created task, and a result processing control for the created task; and
the device is further caused to:
add, to the task list, task information corresponding to the target task and a result processing control corresponding to the target task.

17. The device according to claim 16, wherein the result processing control comprises a result display sub-control and a result download sub-control; and
the device is further caused to:
display the target image on a fourth interface in response to a result display sub-control corresponding to the target task being triggered; and
download the target image in response to a result download sub-control corresponding to the target task being triggered.

18. The device according to claim 17, wherein the fourth interface displays a result comparison setting control; and the instructions causing the processor to display the target image on a fourth interface comprise instructions causing the processor to:
determine arrangement information of a plurality of target images by the result comparison setting control, and display the plurality of target images based on the arrangement information.

19. The device according to claim 18, wherein the result comparison setting control comprises a horizontal setting sub-control and a vertical setting sub-control; and the instructions causing the processor to determine arrangement information of a plurality of target images by the result comparison setting control comprise instructions causing the processor to:
determine at least one first comparison parameter from the target parameters by the horizontal setting sub-control, and determine at least one second comparison parameter from the target parameters by the vertical setting sub-control; and
determine the arrangement information of the plurality of target images based on the first comparison parameter and the second comparison parameter, wherein a plurality of target images arranged in a same row correspond to a same second comparison parameter and different first comparison parameters; and a plurality of target images arranged in a same column correspond to a same first comparison parameter and different second comparison parameters.

20. A non-transitory computer-readable storage medium having instructions stored thereon, wherein instructions performed by a processor, causing the processor to:
display a first interface, wherein the first interface presents a task creation control;
display a second interface in response to the task creation control being triggered, wherein the second interface displays a task name setting control and a parameter setting control;
obtain, by the task name setting control, a name of a target task to be performed, and obtain, by the parameter setting control, a target parameter corresponding to the target task, wherein there is at least one category of target parameters, and each category of the target parameters corresponds to at least one parameter value; and
provide the target parameter to a target generation model causing the target generation model to generate a target image corresponding to the target task based on the target parameter, wherein a number of target images is determined based on a number of parameter values corresponding to each category of the target parameters.
